(19) United States
(12) Patent Application Publication
(10) Pub. No.: US 2006/0294029 A1
(43) Pub. Date: Dec. 28, 2006

(54) Apparatus, method and system for preparation of mailpieces

(75) Inventors: Thomas J. Foth, Trumbull, CT (US); Richard W. Heiden, Shelton, CT (US); Kenneth G. Miller, Bethel, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/158,364

(22) Filed: Jun. 22, 2005

(51) Int. Cl. G06F 17/00

(52) U.S. Cl. 705/401

(57) ABSTRACT

A system, method and apparatus for preparing mailpieces. An inserter system for assembling mailpieces is controlled in accordance with mailpiece records in a mailing control file. The inserter system scans control documents included in the mailpieces to identify corresponding mailpiece records. The records include information identifying a selected method of evidencing payment of postage for particular mailpieces. The system can include a plurality of envelope feeders at least some of which are loaded with envelopes pre-marked with evidence of payment, and can also include a plurality of mechanisms for franking mailpieces prepared with blank envelopes. A data processing system for generating document sets which include control documents is also disclosed.

### BACKGROUND OF THE INVENTION

This invention relates to the preparation of large mailings and the like. More particularly, it relates to systems, and methods of operation of such systems, for the assembly of mailpieces and evidencing payment for such mailpieces (hereinafter “franking”).

The term “mailpieces” as used herein means items intended to be delivered by a postal service or private courier service. Typically, preparation of mailpieces includes, but is not limited to, printing or otherwise providing documents including variable information pertaining to addressees of the mailpieces and the assembly of such documents with other elements of the mailpiece. The term “assembly” as used herein means the execution of actions to incorporate the documents into mailpieces. Typically, such actions can include accumulating documents with other materials such as preprinted inserts; folding and inserting the resulting accumulations into envelopes; and printing addresses and other information on the outside of the envelopes. Typically, before delivery to a postal service, a mailpiece is franked to provide visible evidence that the appropriate postage has been paid for that mailpiece. Methods of franking include, but are not limited to, application of an adhesive postal stamp purchased from the postal service, imprinting of a mailpiece with a permit mail indicium, and imprinting of a mailpiece with a postage meter indicium.

Inserter systems for the preparation of mailpieces are well-known. A typical inserter system can include a burster/feeder which inputs preprinted documents in fanfold form, separates the documents and removes and discards sprocket feed strips from the edges of the document. Each set of documents for a particular mailpiece includes at least a control document. On control documents the feed strips are marked with a code which is read by a scanner before the strips are removed. In simpler systems, code BC can be a “dash code” of the type known for use in directly controlling inserter systems. In newer, more capable systems, the code can be a conventional bar code which serves as a pointer to a mailpiece record which record contains information for controlling the inserter. In other known inserter systems, the documents can be in cut sheet form, and a cut sheet feeder can be used in place of a burster/feeder. The control document and any additional associated pages then are fed from the burster/feeder to an accumulator, where documents for each mailpiece are formed into separate accumulations and folded.

If inserts are to be included in the mailpiece (e.g., advertising inserts) the accumulation is then fed to one or more insert stations where specified inserts are added to the accumulations. Those skilled in the art will recognize that the number of such insert stations used will vary from application to application.

The burster/feeder, scanner, accumulator and insert stations, if any, (or equivalent apparatus) together form what will hereinafter be referred to as an “accumulation station”.

In such known inserter systems, the accumulation is fed from the accumulation station to an envelope feeder where it is inserted into an envelope and sealed to form a mailpiece. The mailpiece is then fed to an address printer which prints a delivery address on the outside of the envelope. Depending on the size of the print field of the printer, the printer also can be used to print other information such as a variable return address or other text message. Those skilled in the art will recognize that dash codes as described above typically cannot include sufficient information to define even a delivery address, so that systems incorporating dash codes typically use window envelopes to provide addressing information and need not include an address printer.

Such systems would then feed the assembled mailpieces to an evidencing station, typically including one or more postage meters preset to different postage amounts, for franking with the appropriate postage amount in a conventional manner.

Known inserter systems also can include an out stacker for diverting mailpieces in any convenient manner when an error is detected. Such error detection and correction form no part of the subject invention and will not be described further here.

As noted above, inserter systems wherein the code is a barcode which is used as a pointer to a mailpiece record (i.e., an electronic record associated with a mailpiece to be assembled) are known. By incorporating data for controlling assembly of mailpieces in mailpiece records, an essentially unlimited amount of data can be associated with each mailpiece. Thus addresses, return addresses, logos, and postal bar codes can be specified in addition to specification of the number of inserts to be added at each insert feeder, postage amounts, etc. Systems incorporating such mailpiece records are described in commonly assigned U.S. Pat. No. 4,800,505 to Axelrod et al. entitled “Mail Preparation System” issued Jan. 24, 1989, which is hereby incorporated by reference. Embodiments of the system of U.S. Pat. No. 4,800,505 are marketed by the assignee of the present application under the name “Direct Connection”, described in The Direct Connection, version 1.30.

While systems such as those described above have proven highly successful, certain disadvantages remain. It is well known that recipients of mailpieces prepared as part of large mailings often think of such mailpieces as “junk mail” and discard such junk mail without opening it. Thus, mailers who send such large mailings are vitally concerned with the “openability” of mailpieces. That is, mailers are concerned with the degree to which the external appearance of a mailpiece will influence the recipient to open the mailpiece and at least briefly consider the contents. In particular, it is known that some recipients base their decision to open or not open a mailpiece, at least in part, on the particular method chosen to frank that mailpiece e.g., stamp, meter indicia, permit indicia, etc.

Thus it is an object of the subject invention to provide a system and method for the preparation of mailpieces having improved openability.

### SUMMARY OF THE INVENTION

The above object is achieved and the disadvantages of the prior art are overcome in accordance with the subject invention by means of an apparatus and a system and method for preparing mailpieces and the like. The system includes: a) a data processing system for generating a document set, the set including a control document; the data processing system including: a data processor; a preference data store for storing a database of recipient preferences for methods of evidencing payment of postage for the mailpiece, a document data store, for storing a database of document data; and a printer system responsive to the data processor for printing the document sets; wherein the data processing system is programmed to access the document data store to recover document data for the mailpiece from the document data database; control the printer system to print the document set in accordance with the recovered document data; access the preference data store to recover a recipient evidencing preference for the mailpiece from the evidencing preferences database; and control the printer system to print the control document with a code indicative of the evidencing preference for the mailpiece. The system also includes an inserter system for preparing a mailpiece, the mailpiece including the document set; the inserter system including a plurality of apparatus for evidencing payment of postage for the mailpiece, each of the apparatus providing a different method of evidencing; a scanner for scanning the control document to recover the code; an envelope feeder station for inserting an accumulation, the accumulation including the control document, into an envelope to form a mailpiece; and a controller responsive to the scanner to select a method of evidencing payment for the mail piece in accordance with said code and to control the inserter system to select one of the apparatus in accordance with the selected method.

In accordance with one aspect of the subject invention, the apparatus includes an inserter system where the envelope feeder station includes a plurality of envelope feeders, the evidencing apparatus including at least one of the envelope feeders, the one envelope feeder providing envelopes pre-marked with evidence of payment, the controller selecting one of the feeders in accordance with the code.

In accordance with another aspect of the subject invention, the evidencing apparatus includes an evidencing station, the evidencing station including a plurality of evidencing mechanisms for marking a blank envelope with a different form of evidence of payment, and the envelope feeder station includes an envelope feeder for providing blank envelopes, the controller being responsive to the scanner to select the blank envelope feeder and one of the mechanisms in accordance with the code.

In accordance with still another aspect of the subject invention, a method for generating a document and for preparing a mailpiece containing the document includes the steps of accessing a document database to recover document data for the mailpiece; printing the document in accordance with the recovered document data; accessing a database of recipient preferences for methods of evidencing payment of postage to recover a recipient evidencing preference for the mailpiece; printing the document with a code indicative of the recovered evidencing preference for the mailpiece; and inputting the document to an inserter system for preparing a mailpiece, the inserter system including a plurality of apparatus for evidencing payment of postage for the mailpiece, each of the apparatus providing a different method of evidencing; and controlling the inserter system to select one of the apparatus in accordance with the code.

In accordance with still another aspect of the subject invention, the code directly represents a method of evidencing payment of postage for the mailpiece.

In accordance with still another aspect of the subject invention, the code is a pointer to a mailpiece record, the mailpiece record identifying a method of evidencing payment of postage for the mailpiece.

Other objects and advantages of the subject invention will be apparent to those skilled in the art from the detailed description set forth below and the attached drawings.

### BRIEF DESCRIPTION OF THE DRAWINGS

The present invention is illustrated by way of example, and not by way of limitation, in the figures of the accompanying drawings and in which like reference numerals refer to similar elements or steps and in which:

FIGS. 1a and 1b show a schematic block diagram of an inserter system in accordance with the subject invention.

FIG. 1c shows a more detailed plan view of control document CD.

FIG. 2 shows a flow diagram of the operation of the system of FIGS. 1a and 1b.

FIG. 3 shows a schematic block diagram of a data processing system for producing document sets to be incorporated into mailpieces in accordance with the subject invention.

FIG. 4 shows a flow diagram of the operation of the system of FIG. 3.

### DETAILED DESCRIPTION OF PREFERRED EMBODIMENTS OF THE SUBJECT INVENTION

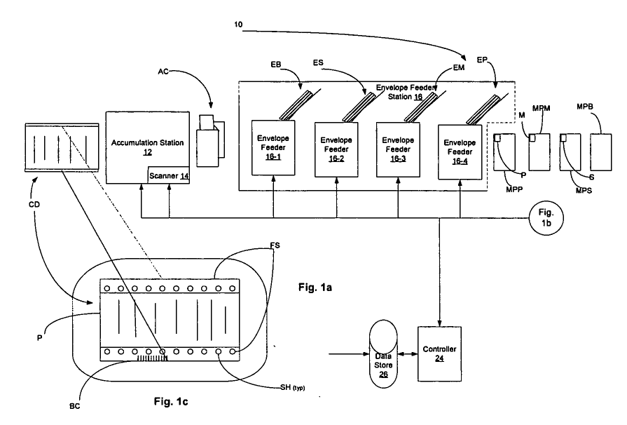

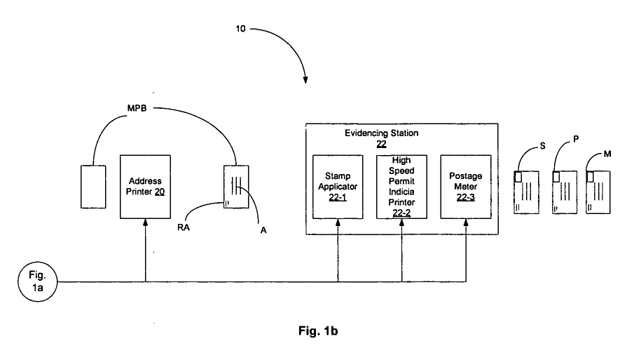

FIGS. 1a and 1b together show inserter system 10, which includes a conventional accumulation station 12, station 12 including a conventional scanner 14 and other conventional apparatus (not shown) for inputting a document set including at least a control document CD and forming an accumulation AC in a known manner. System 10 also includes envelope feeder station 16 for inserting accumulation AC into an envelope to form a mailpiece, a conventional address printer 20 (shown in FIG. 1b) for printing address information onto mailpieces in a conventional manner, and an evidencing station 22 (shown in FIG. 1b) for printing, or otherwise applying, evidence of the payment of postage to a mailpiece. System 10 is controlled by controller 24 to prepare mailpieces in accordance with mailpiece records stored in data store 26, as will be described further below. Mailpieces are transported through system 10 by any convenient transport system (not shown).

FIG. 1c shows a more detailed plan view of control document CD, which includes printed page P, feed strips FS, having sprocket holes SH, removably affixed to the edges of page P, and a barcode BC printed on one of strips FS. Code BC is a pointer to one of the above described mailpiece records which record contains information for controlling the inserter. In other embodiments of the invention, different forms of coding such as optical character recognition, magnetic ink recognition or two-dimensional barcodes can be used. By incorporating data in mailpiece records for controlling preparation of mailpieces an essentially unlimited amount of data can be associated with each mailpiece. Thus, addresses, return addresses, logos, and postal barcodes can all readily specified in addition to specification of the number of inserts to be added at each insert feeder, postage amounts, etc.

Systems incorporating such mailpiece records are described in aforementioned commonly assigned U.S. Pat. No. 4,800,505.

In simpler systems, code BC can be a “dash code” of the type known for use in directly controlling inserter systems, and can directly represent a method of evidencing. In either case, control of such aspects, other than the method of evidencing payment of postage for the preparation of mailpieces is known, and further description here is not necessary for an understanding of the subject invention.

Returning to FIG. 1a, envelope feeder station 16 includes envelope feeder 16-1 for feeding a blank (i.e., unfranked) envelope EB, envelope feeder 16-2 for feeding a pre-stamped envelope ES, envelope feeder 16-3 for feeding a pre-metered envelope EM, and envelope feeder 16-4 for feeding an envelope having a preprinted permit indicium EP. Feeders 16-1, 16-2, 16-3 and 16-4 are conventional and substantially the same, and are mainly distinguished by the type of envelope which they feed. Depending upon which envelope feeder is selected, accumulation AC is inserted into an envelope and sealed to form mail piece MPP, franked with permit indicium P; mailpiece MPS, franked with stamp S; mailpiece MPM, franked with meter indicium M; or mailpiece MPB, which is unfranked.

Turning now to FIG. 1b, evidencing station 22 includes stamp applicator 22-1 for applying adhesive stamps to a mailpiece, high speed permit indicia printer 22-2 for printing permit indicia on a mailpiece, and postage meter 22-3 for metering a mailpiece, which are all known conventional apparatus. After mailpiece MPB is printed with delivery address A and return address RA by address printer 20, it is fed to evidencing station 22 where, depending upon whether stamp applicator 22-1, printer 22-2, or meter 22-3 is selected mail piece MPP, franked with permit indicium P; mailpiece MPS, franked with stamp S; mailpiece MPM, franked with meter indicium M, are formed.

It should be noted that only a mailpiece formed with a blank envelope will be franked by evidencing station 22, and that mailpieces formed with pre-marked envelopes, after addressing, are diverted around station 22 or, in other embodiments of the subject invention, simply are transported through station 22 without any operation taking place. It should also be noted that in other embodiments of the subject invention, address information can be provided through use of window envelopes and printer 20 can be omitted.

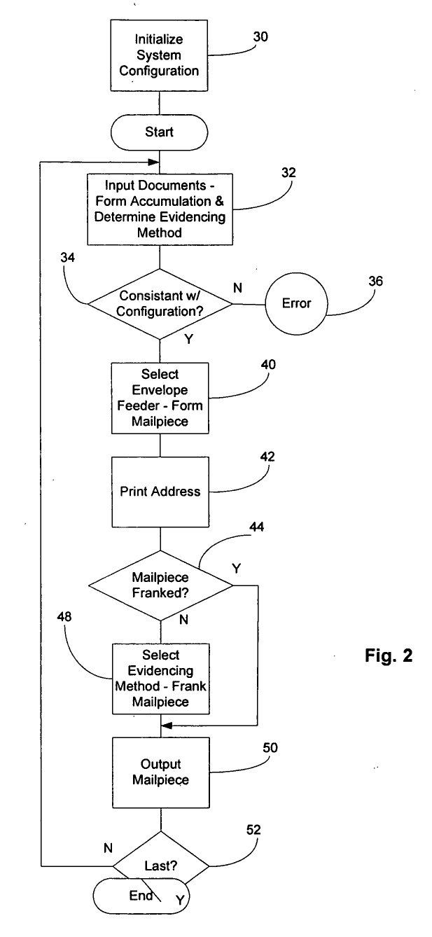

FIG. 2 shows a flow diagram of the operation of controller 24 in carrying out the method of the subject invention. Initially, at step 30, the configuration of system 10 is defined in any convenient manner. Particularly, this configuration information will define which envelope types are loaded in which envelope feeders, and which mechanisms for evidencing payment are installed at station 22.

The program starts and then at step 32, controller 24 controls system to input a document set, including at least control document CD, and controls accumulation station 12 to form accumulation AC in a conventional manner. As accumulation AC is formed, controller 24 controls scanner 14 to read code BC, which is a pointer to a mailpiece record, from one of strips FS and accesses a corresponding mailpiece record in data store 26 to determine which method of payment evidencing has been selected. As described above, the mailpiece record can also define other parameters for preparation of the mailpiece. Implementation of these parameters during preparation of a mailpiece by system 10 is conventional and need not be discussed further here for an understanding of the subject invention.

At step 32, controller 24 determines if the selected method of evidencing is not consistent with the configuration of system 10, e.g., calls for a pre-stamped envelope when no pre-stamped envelopes have been loaded. If the selected method is inconsistent with the configuration of system 10 controller 24 goes to error routine 36; details of which form no part of the subject invention.

Otherwise, at step 40, controller 24 selects an envelope feeder at envelope feeder station 16 in accordance with the selected method of evidencing and controls the selected feeder to form an appropriate mailpiece: MPP, MPM, MPS, or MPB. Then, at step 42, controller 24 controls address printer 20 to print delivery address A and return address RA on the mailpiece in a conventional manner. In other embodiments of the subject invention, printer 20 can also print additional material such as additional messages or logos on a mailpiece; and, in still other embodiments, address information can be provided by use of window envelopes.

At step 44, controller 24 determines if the mailpiece is franked, that is, if an envelope which is pre-marked with evidence of payment has been selected, or if a blank envelope has been selected. If a pre-marked envelope has been selected, controller 24 goes to step 50 and controls system 10 to output the mailpiece. If a pre-marked mail piece has not been selected, controller 24 goes to step 48. In step 48, controller 24 selects the appropriate mechanism at evidencing station 22. The mechanism may be a stamp applicator 22-1, a high speed permit indicia printer 22-2, or a postage meter 22-3, all of which are known and which need not be discussed further here for an understanding of the subject invention. Station 22 franks the mailpiece forming an appropriate mailpiece: MPS, MPP, or MPM; and goes to step 50.

Then at step 52, controller 24 determines if this is the last mailpiece. If so the program ends, and otherwise returns to step 32.

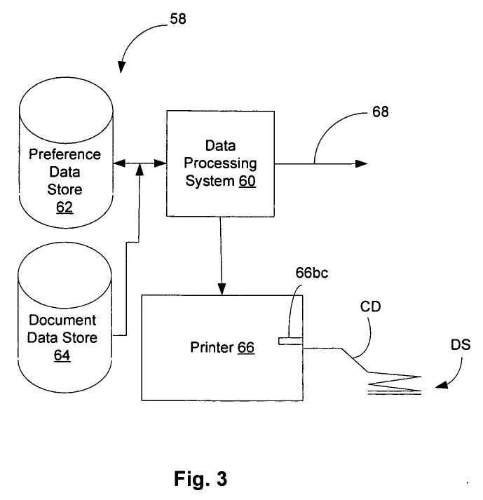

FIG. 3 shows data processing system 58 for generating document sets to be incorporated in mailpieces and for maintaining mailpiece records which identify a recipient's evidencing preferences. System 58 includes data processor 60 which communicates with preference data store 62, which stores a database of recipient evidencing preferences, document data store 64, which stores document data, and printer system 66 for printing document sets. System 58 also includes communications link 68 (also shown in FIG. 1a) for download and updating mailpiece records stored in data store 26 (shown in FIG. 1a). Link 68 can take any convenient form; or, in other embodiments of the subject invention, various data stores can share a commonly accessible storage structure.

Compilation of databases of the affect on openability of various external features of a mailpiece is known and is typically done by means of contests or lotteries, where a recipient's entry will show that the mailpiece has been opened. Alternatively, techniques such as surveys or focus groups can be used.

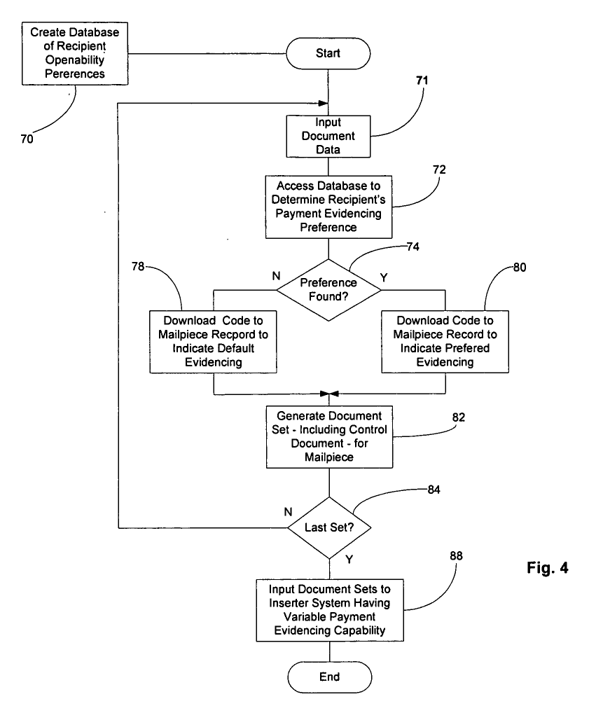

FIG. 4 shows flow diagram of the operation of data processing system 60 in generating document sets to be used in preparing mailpieces in accordance with the subject invention. Initially, at step 70, a database of recipient evidencing preferences (in terms of mailpiece openability) is created and stored in data store 62 in any convenient manner. At step 71 processor 60 inputs document data for a set of documents, including a control document, from data store 64. The document data includes text to be printed on the documents and address information and can include other data for control of an inserter system, such as return addresses, logos, and postal bar codes, specification of the number of inserts to be added at each insert feeder, postage amounts, etc.

Then at step 72, processor 60 accesses preference database 62 to determine the recipient's preference as to the method used to evidence payment of postage for the mailpiece, and at step 74 determines if such a preference has been found. If no preference is found, then at step 78, processor 60 downloads a code indicating a default evidencing method to a corresponding mailpiece record in data store 26 (shown in FIG. 1a). Otherwise, at step 80, processor 60 downloads a code indicating a preferred evidencing method to the corresponding mailpiece record. At this step processor 80 can also down load other document data for control of an inserter system to the mailpiece record.

Then, at step 82, processor 60 controls printer system 66 to generate document set DS, including control document CD, for the mailpiece. Control Document CD is printed with appropriate text and with code BC, preferably on feed strips FS (shown in FIG. 1c). Code BC serves as a pointer to a corresponding mailpiece record stored in data store 26 (shown in FIG. 1a). In other embodiments of the subject invention where mailpiece records are not used, code BC can directly specify an evidencing method as well as other (typically more limited) document data for controlling an inserter system, as described above.

Where the print field of printer system 66 will not accommodate printing on strips FS, printer system 66 can include an auxiliary barcode printer system 66bc (shown in FIG. 3) for printing code BC.

Then, at step 84, processor 60 determines if this is the last set of documents and, if not, returns to step 71. Otherwise, at step 88, document set DS and other accompanying sets are input to inserter system 10 (shown FIGS. 1a and 1b) in any convenient manner, and the program ends.

The embodiments described above and illustrated in the attached drawings have been given by way of example and illustration only. From the teaching of the present application, those skilled in the art will readily recognize numerous other embodiments in accordance with the subject invention. Particularly, those skilled in the art will recognize that the mechanisms for evidencing payment of postage shown in FIGS. 1a and 1b are primarily included to illustrate the range of methods contemplated by the subject invention, and it is believed likely that all the mechanisms shown will not be used in a particular implementation of the subject invention. For example, it is believed that an application generally will not require both a pre-stamped envelope feeder and a stamp applicator. Conversely, where a mailing includes mailpieces requiring differing amounts of postage, duplicate mechanisms, such as a plurality of postage meters preset to different amounts can be used. Further it should be recognized that methods of evidencing postage payment other than those shown here, whether presently known or later developed, which are compatible with inserter systems, are within the contemplation of the subject invention. Accordingly, limitations on the subject invention are to be found only in the claims set forth below.

What is claimed is:

1. A system for generating a document and for preparing a mailpiece containing said documents, said system comprising:
a) data processing system for generating a document set, said set including a control document, said data processing system comprising:
a1) a data processor;
a2) a preference data store for storing a database of recipient preferences for methods of evidencing payment of postage for said mailpiece,
a3) a document data store, for storing a database of document data; and
a4) a printer system responsive to said data processor for printing said document sets; where
a5) said data processing system is programmed to:
a5.1) access said document data store to recover document data for said mailpiece from said document data database;
a5.2) control said printer system to print said document set in accordance with said recovered document data;
a5.3) access said preference data store to recover a recipient evidencing preference for said mailpiece from said evidencing preferences database; and
a5.4) control said printer system to print said control document with a code indicative of said recovered evidencing preference for said mailpiece; and
b) an inserter system for preparing said mailpiece, said inserter system comprising:
b1) a plurality of apparatus for evidencing payment of postage for said mailpiece, each of said apparatus providing a different method of evidencing;
b2) scanner for scanning said control document to recover said code;
b3) an envelope feeder station for inserting an accumulation, said accumulation including said control document, into an envelope to form a mailpiece; and
b4) a controller responsive to said scanner to select a method of evidencing payment for said mail piece in accordance with said code and to control said inserter system to select one of said apparatus in accordance with said selected method.

2. A system as described in claim 1 where said code directly represents a method of evidencing payment of postage for said mailpiece.

3. A system as described in claim 1 where said code is a pointer to a mailpiece record, said mailpiece record identifying a method of evidencing payment of postage for said mailpiece.

4. An inserter system for preparation of a mailpiece, said mailpiece including a control document, said control document including a code, said inserter system comprising:
a) a plurality of apparatus for evidencing payment of postage for said mailpiece, each of said apparatus providing a different method of evidencing;
b) scanner for scanning said control document to recover said code;
c) an envelope feeder station for inserting an accumulation, said accumulation including said control document, into an envelope to form a mailpiece; and
d) a controller responsive to said scanner to select a method of evidencing payment for said mail piece in accordance with said code and to control said inserter system to select one of said apparatus in accordance with said selected method.

5. An inserter system as described in claim 4 where said envelope feeder station comprises a plurality of envelope feeders, said evidencing apparatus including at least one of said envelope feeders, said at least one envelope feeder providing envelopes pre-marked with evidence of payment, said controller selecting one of said feeders in accordance with said code.

6. An inserter system as described in claim 5 where said evidencing apparatus includes an evidencing station, said evidencing station comprising a plurality of evidencing mechanisms for marking a blank envelope with a different form of evidence of payment, and said envelope feeder station comprises an envelope feeder for providing blank envelopes, said controller being responsive to said scanner to select said blank envelope feeder and one of said mechanisms in accordance with said code.

7. An inserter system as described in claim 4 where said evidencing apparatus includes an evidencing station, said evidencing station comprising a plurality of evidencing mechanisms for marking a blank envelope with a different form of evidence of payment, and said envelope feeder station comprises an envelope feeder for providing blank envelopes, said controller being responsive to said scanner to select said blank envelope feeder and one of said mechanisms in accordance with said code.

8. An inserter system as described in claim 4 where said code directly represents a method of evidencing payment of postage for said mailpiece.

9. An inserter system as described in claim 4 where said code is a pointer to a mailpiece record, said mailpiece record identifying a method of evidencing payment of postage for said mailpiece.

10. A data processing system for generating control documents for incorporation into mailpieces containing, said system comprising:
a) a data processor;
b) a preference data store for storing a database of recipient preferences for methods of evidencing payment of postage for said mailpiece,
c) a document data store, for storing a database of document data; and
d) a printer system responsive to said data processor for printing said document sets; where
e) said data processing system is programmed to:
e1) access said document data store to recover document data for said mailpiece from said document data database;
e2) control said printer system to print said document set in accordance with said recovered document data;
e3) access said preference data store to recover a recipient evidencing preference for said mailpiece from said evidencing preferences database; and
e4) control said printer system to print said control document with a code indicative of said recovered evidencing preference for said mailpiece.

11. A data processing system as described in claim 10 where said code directly represents a method of evidencing payment of postage for said mailpiece.

12. A data processing system as described in claim 10 where said code is a pointer to a mailpiece record, said mailpiece record identifying a method of evidencing payment of postage for said mailpiece.

13. A method for generating a document, and for preparing a mailpiece containing said document, said method comprising the steps of:
a) accessing a document database to recover document data for said mailpiece;
b) printing said document in accordance with said recovered document data;
c) accessing a database of recipient preferences for methods of evidencing payment of postage to recover a recipient evidencing preference for said mailpiece; and
d) printing said document with a code indicative of said recovered evidencing preference for said mailpiece; and
e) inputting said document to an inserter system for preparing a mailpiece, said inserter system comprising a plurality of apparatus for evidencing payment of postage for said mailpiece, each of said apparatus providing a different method of evidencing; and
f) controlling said inserter system to select one of said apparatus in accordance with said code.

14. A method as described in claim 13 where said code directly represents a method of evidencing payment of postage for said mailpiece.

15. A method as described in claim 13 where said code is a pointer to a mailpiece record, said mailpiece record identifying a method of evidencing payment of postage for said mailpiece.

16. A method for preparing a mailpiece containing a document, said document being marked with a code, said method comprising the steps of:
a) inputting said control document to an inserter system for preparing a mailpiece, said inserter system comprising a plurality of apparatus for evidencing payment of postage for said mailpiece, each of said apparatus providing a different method of evidencing:
b) controlling said inserter system to select one of said apparatus in accordance with said code.

17. A method as described in claim 16 where said code directly represents a method of evidencing payment of postage for said mailpiece.

18. A method as described in claim 16 where said code is a pointer to a mailpiece record, said mailpiece record identifying a method of evidencing payment of postage for said mailpiece.

19. A mailpiece comprising a document, said document being marked with a code, said code being indicative of a method of evidencing payment of postage used for said mailpiece.

20. A mailpiece as described in claim 19 where said code directly represents a method of evidencing payment of postage for said mailpiece.

21. A method as described in claim 19 where said code is a pointer to a mailpiece record, said mailpiece record identifying a method of evidencing payment of postage for said mailpiece
